(19) United States
(12) Patent Application Publication
(10) Pub. No.: US 2008/0079696 A1
(43) Pub. Date: Apr. 3, 2008

(54) Terminal and display method thereof

(75) Inventors: Jung-hyun Shim, Seongnam-si (KR); Chang-su Kim, Suwon-si (KR); Stanley Chung, Seoul (KR); Soon-joo Kwon, Seongnam-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., Ltd., Suwon-si (KR)

(21) Appl. No.: 11/892,645

(22) Filed: Aug. 24, 2007

(30) Foreign Application Priority Data
Oct. 2, 2006 (KR) 10-2006-0097442
May 16, 2007 (KR) 10-2007-0047832

(51) Int. Cl. G09G 5/00

(52) U.S. Cl. 345/170

(57) ABSTRACT

Provided are a terminal and a display method of the terminal which recognize the result of operating at least some of a plurality of buttons, and display a plurality of images corresponding to the recognized result on the buttons according to techniques which are preset for each of the images. Thus, operational convenience can be maximized for a user who operates the buttons on the terminal, which is compact and has various applicable functions, in order to indicate a certain function.

### CROSS-REFERENCE TO RELATED PATENT APPLICATIONS

This application claims the priority of Korean Patent Application Nos. 10-2006-0097442, filed on Oct. 2, 2006 and 10-2007-0047832, filed on May 16, 2007, in the Korean Intellectual Property Office, the disclosure of which is incorporated herein in its entirety by reference.

### BACKGROUND OF THE INVENTION

1. Field of the Invention

The present invention relates to a terminal such as a mobile telephone, and more particularly, to a terminal having a plurality of buttons, and a display method thereof.

2. Description of the Related Art

In a typical terminal having a plurality of buttons, if each button has a variety of functions, the button has letters that indicate the functions. When a user wants to activate one of functions, the user selects one of buttons according to the letters on the buttons.

The more functions a terminal has, the more functions are applied to each button, the smaller the terminal becomes, and the smaller each button on the terminal becomes.

Therefore, since compact terminals which have various functions have recently become widely popular, it is inevitable that there are users who are complaining of the difficulty of operating the small buttons, especially, users who are unfamiliar with the button operation.

Accordingly, it is required to maximize operational convenience for the users who operate buttons on a compact terminal which has a variety of usable functions.

### SUMMARY OF THE INVENTION

The present invention provides a terminal which is compact and provides maximum operational convenience for users who operate buttons on the terminal in order to instruct the terminal to perform a specific function.

The present invention also provides a display method of a terminal which is compact and provides maximum operational convenience for users who operate buttons on the terminal in order to instruct the terminal to perform a specific function.

The present invention also provides a computer readable recording medium having embodied thereon a computer program for executing the method of maximizing operational convenience for users who operate buttons on a compact terminal in order to instruct the terminal to perform a specific function.

According to an aspect of the present invention, there is provided a terminal comprising: a plurality of buttons which display a plurality of images in response to a control signal; and a control unit which generates the control signal corresponding to a result of operating at least some of the plurality of buttons, the control signal directing the buttons to display the images according to techniques, each of the techniques is preset for each of the images.

According to another aspect of the present invention, there is provided a display method which is performed in a terminal having a plurality of buttons, the display method comprising: recognizing a result of operating at least some of the buttons; and displaying a plurality of images corresponding to the recognized result on the buttons according to techniques, each of the techniques is preset for each of the images.

According to yet another aspect of the present invention, there is provided a computer readable recording medium having embodied thereon a computer program for executing a display method which is performed in a terminal having a plurality of buttons, the display method comprising: recognizing a result of operating at least some of the buttons; and displaying a plurality of images corresponding to the recognized result on the buttons according to techniques, each of the techniques is preset for each of the images.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a terminal according to an embodiment of the present invention;

FIG. 2 illustrates an example of a folder-type terminal according to an embodiment of the present invention;

FIGS. 3-5, 6A, 6B, 7A, 7B, and 8-10 are for explaining features of the terminal illustrated in FIG. 2; and

FIG. 11 is a flowchart of a display method according to an embodiment of the present invention.

### DETAILED DESCRIPTION OF THE INVENTION

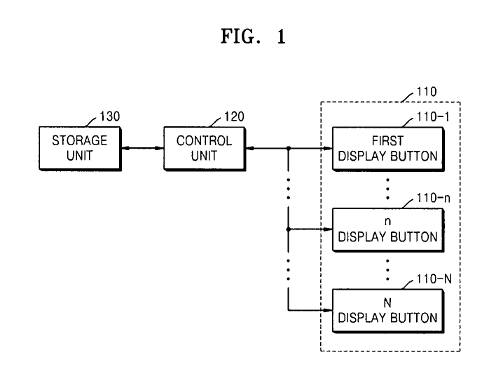

FIG. 1 is a block diagram of a terminal according to an embodiment of the present invention. Referring to FIG. 1, the terminal includes a plurality of buttons 110, a control unit 120, and a storage unit 130.

The plurality of buttons 110 may includes N display buttons 110-1, 110-2, through to 110-n, through to 110-N (where n and N are constant numbers and 1<n≦N), and one or more other buttons (now shown). Here, the display buttons have display functions, and the other buttons do not have display functions. The N display buttons 110-1, 110-2, through to 110-N can be shown in a screen which is divided into N sections.

The control unit 120 generates control signals according to inputs through the buttons. The button may be the display buttons 110-1, 110-2, through to 110-N, or the other buttons. Specifically, in response to the control signals, N predetermined images are displayed on the N display buttons 110-1, 110-2, through to 110-N, according to predetermined techniques each of which corresponds to each of the N images. For example, a control signal that is k-th generated is determined corresponding to images, which are (k−1)th displayed on the N display buttons 110-1, 110-2, through to 110-N, and the result of k-th operating some of the plurality of buttons 110.

The predetermined images are previously stored in the storage unit 130. The storage unit 130 may be placed in the terminal or may be provided externally. Unlike the storage unit 130, the plurality of buttons 110 and the control unit 120 are desirably placed in the terminal.

The control unit 120 reads a plurality of images from the storage unit 130 corresponding to the result of operating the buttons, and instructs the display buttons 110 to display the read images according to predetermined techniques for each image.

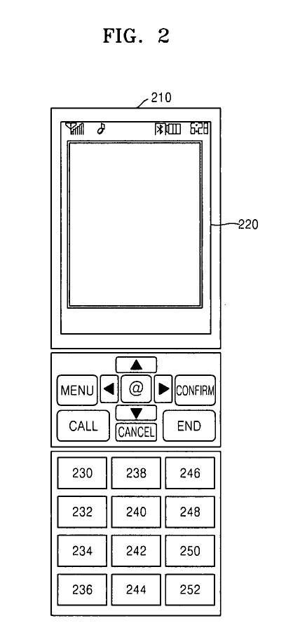

FIG. 2 illustrates an example of a folder-type terminal 210 according to an embodiment of the present invention. Specifically, FIG. 2 shows the opened terminal 210.

Referring to FIG. 2, the terminal 210 includes a main display portion 220, twelve display buttons 230, 232, 234, through to 252, and a plurality of non-display buttons (menu buttons, direction key buttons ▴, ▾, [symbol] and [symbol] a confirm button, a call button, a cancel button, and an end button).

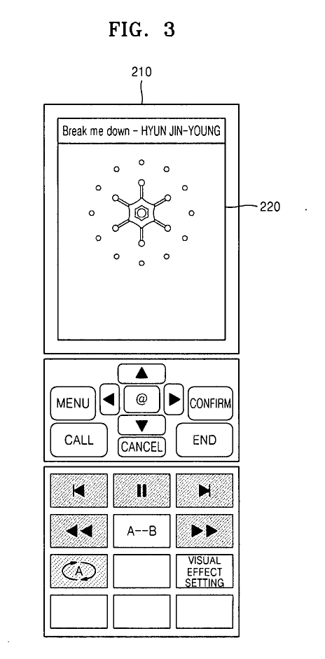

FIGS. 3 through 10 are for explaining features of the terminal 210 in FIG. 2 according to an embodiment of the present invention.

With reference to FIGS. 3 through 5, the terminal 210 according to the present invention will now be explained.

Referring to FIGS. 3 through 5, technique that is preset for each of the images to be displayed on each of the display buttons 230 to 252 define which color will be used for displaying each image. The color may have a hue component, a brightness component, and a saturation component. In FIGS. 3 through 5, image is displayed on the display button according to the predetermined color. In the present invention, the image a include mark which is composed of numbers, letters, and symbols, and the background color of the mark.

As shown in FIG. 3, the terminal 210 is playing music. Specifically, the terminal 210 can play music files according to a predetermined order, and is currently playing a music file named “break me down” which is sung by “Hyun Jin-young.”

When a user operates the display button 230, the terminal 210 starts playing a previous music file instead of the current played music file according to the predetermined order, and when the user operates the display button 232, the terminal 210 plays the first music file among a plurality of music files. In the same manner, when the user operates the display button 246, the terminal 210 starts playing the next music file according to the predetermined order, and when the user operates the display button 248, the terminal 210 plays the last music file among the plurality of music files. Also, when the user operates the display button 238, the terminal 210 stops playing a music file, and when the user operates the display button 234, the terminal 210 is set to repeat playing all the music files again after playing the last music file.

When the user operates the display button 240, the terminal 210 recognizes the starting point of a section which will be repeatedly played, and when the user operates the display button 240 again, the terminal 210 recognizes the end point of the section, and repeats the section at certain times. When the user operates the display button 250, the main display portion 220 displays candidates of image to be displayed on the main display portion 220, and when the user operates the terminal 210 to select one of the candidates, the main display portion 220 displays the selected candidate image thereon.

In FIG. 3, the background color of the images displayed on the display buttons 230, 234, 238, 246, or 248 differs from the background color of the images displayed on the display buttons 240 or 250. The background color of the images on the display buttons 230, 232, 234, 238, 240, 246, or 250 may be determined according to functions indicated by the images displayed on the display buttons.

Specifically, in FIG. 3, while the functions of the images displayed on the display buttons 230, 232, 234, 238, 246, or 248 are-performed by the terminal 210 once the corresponding buttons are operated, the functions denoted by the images on the display buttons 240 or 250 need additional operation of the terminal 210 in order to be operated even when the corresponding buttons are operated.

More specifically, the function denoted by the image displayed on the display button 230, that is, the function which allows the user to play the previous music file instead of the currently played music file is performed by the terminal 210 once the display button 230 is operated, and the function denoted by the image displayed on the display button 232, that is, the function which allows the user to play the first music file among the plurality of music files is performed by the terminal 210 once the display button 232 is operated. Also, the function denoted by the image displayed on the display button 246, that is, the function which allows the user to play the next music file instead of the currently played music file is performed by the terminal 210 once the display button 246 is operated, and the function denoted by the image displayed on the display button 248, that is, the function which allows the user to play the last music file among the plurality of music files is performed by the terminal 210 once the display button 248 is operated. In addition, the function denoted by the image displayed on the display button 238, that is, the function which allows the user to stop playing the music file is performed by the terminal 240 once the display button 238 is operated, and the function denoted by the image displayed on the display button 234, that is, the function which allows the user to set the terminal 210 to repeat playing all the music files again after playing the last music file is performed by the terminal 210 once the display button 234 is operated.

Meanwhile, the function denoted by the image displayed on the display button 240, that is, the function which allows the user to repeat playing a particular section of the currently played music file at certain times needs at least one or more additional operations of the terminal 210 although the display button 240 is operated. In other words, in order to repeat playing the section, firstly the display button 240 is operated to enable the terminal 210 to recognize the starting point of the section and then is operated again to allow the terminal 210 to recognize the end point. In a similar way, the function denoted by the image displayed on the display button 250, that is, the function which allows the user to select an image to be displayed on the main display portion 220 from thumbnails of images which are displayed on the main display portion 220 needs at least one or more additional operations of the terminal 210 although the display button is operated. That is, when the user first operates the display button 250, the thumbnails of the images are displayed on the main display portion 220, and then when the user selects one image from the thumbnails by operating the terminal 210, the main display portion 220 displays the image thereon.

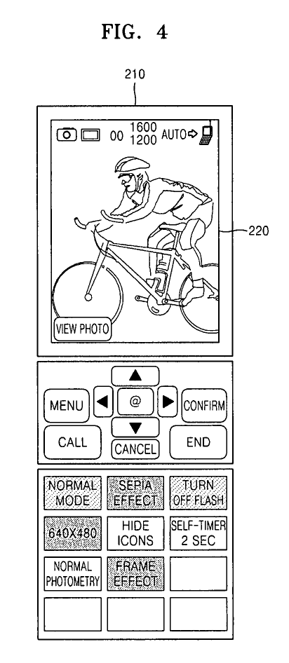

Referring to FIG. 4, the terminal 210 is performing a photographing function. More specifically, the main display portion 220 displays the external image input through a camera mounted in the terminal 210, and the user operates a button (for example, a “confirm” button) on the terminal 210 to capture an image which is currently displayed on the main display portion 220.

In FIG. 4, the display button 240 allows the user to set a photograph mode, the display button 232 allows the user to set the resolution, the display button 234 allows the user to set photometry, and the display button 238 allows the user to use a sepia effect on a captured image, which makes the image look old and faded. Also, the display button 240 allows the user to hide icons from the main display portion 220, the display button 242 allows the user to apply a frame image to a photographed image, the display button 246 allows the user to turn on a flash, and the display button 248 allows the user to set a self-timer.

In FIG. 4, the background color of the images displayed on the display buttons 230 or 246, the background color of the image displayed on the display buttons 232, 238, or 242, and the background color of the images displayed on the display buttons 234, 240, or 248 differ from one another. The background colors may be decided according to how many times the images are displayed on the display buttons 230, 232, 234, 238, 240, 242, 246, or 248 at a predetermined period of time.

For example, when the user operates the display buttons 232, 238, and 242 every time when capturing an image using the terminal 210, the display buttons 230 and 246 are only used sometimes, and the display buttons 234, 240, and 248 are never used during the capturing of an image, and the background colors and the brightness of the images on the display buttons 232, 238, and 248, and 230 and 246, and 234, 240, and 248 are different from one another.

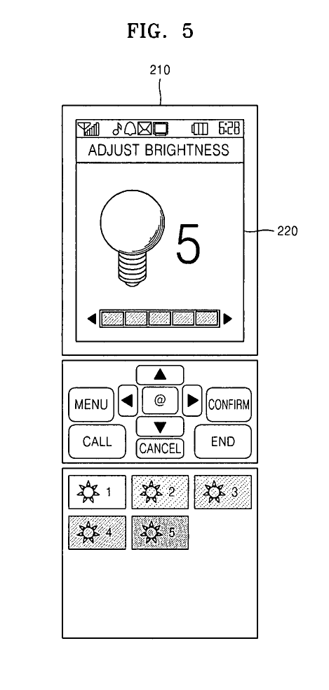

Referring to FIG. 5, the user wants to adjust the brightness of the main display portion 220, and the main display portion 220 displays a light bulb image, the brightness of which varies, and the display buttons 230, 232, 238, 240, and 246 respectively display images with different brightnesses. The colors of the images displayed on the display buttons 230, 232, 238, 240, and 246 may be predetermined according to values that the images show. Therefore, the user can adjust the brightness of the main display portion 220 by operating one of display buttons 230, 232, 238, 240, and 246 only once without pressing a certain button (for example, the [symbol] button) several times.

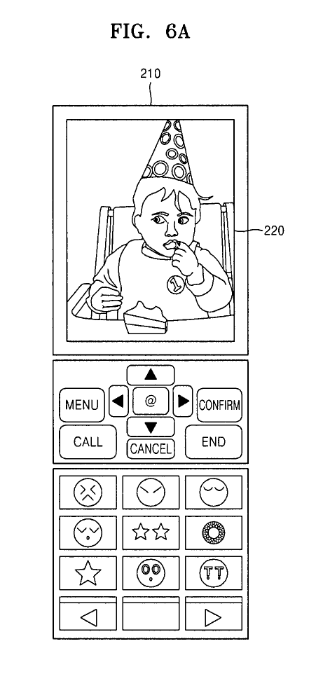

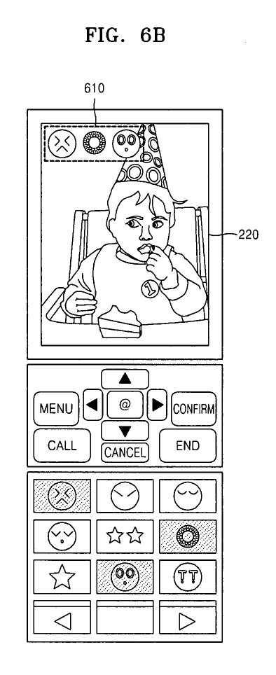

Referring to FIGS. 6A and 6B, the terminal 210 is performing the photographing function. More specifically, the main display portion 220 displays the external image input through a camera mounted in the terminal 210, and the user operates a button (for example, a “confirm” button) on the terminal 210 to capture an image which is currently displayed on the main display portion 220.

In FIGS. 6A and 6B, when some of the display buttons 230, 232, 234, 238, 240, 242, 246, and 248 are operated, the images displayed on the operated buttons 230, 248, and 242 are displayed on the main display portion 220 as shown by the numeral reference 610 in FIG. 6B, and then when the user photographs the currently displayed image on the main display portion 220, a photo of the image with the images of the selected buttons 230, 248, and 242 is produced. The number of the images that can be included in a photo is not limited to nine, and if the available images are more than nine, the user may operate the buttons 236 or 252 to scroll through the images.

Referring to FIG. 6B, the operated display buttons 230, 242, and 248 displays the images that are distinguished from the images on the other display buttons 232, 234, 236, 238, 240, 244, 246, 250, and 252. For example, the images displayed on the operated display buttons 230, 242, and 248 may blink periodically. Thus, the user can easily recognize which buttons he or she operates.

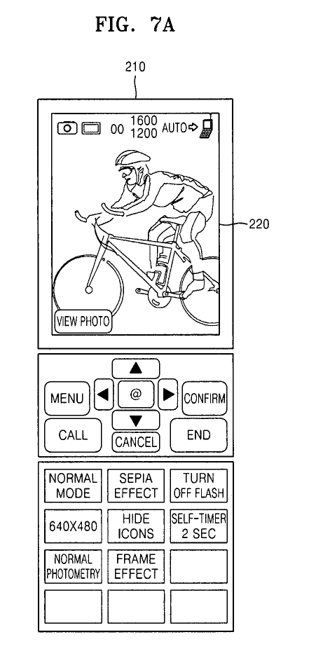

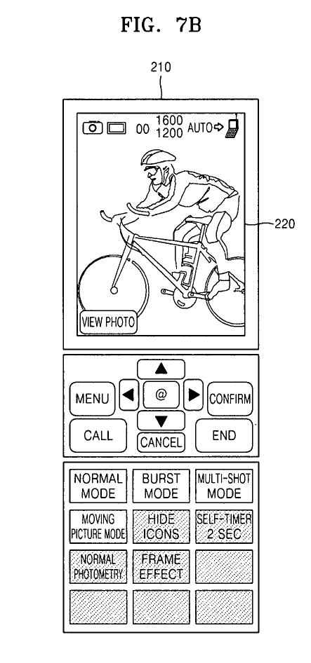

Referring to FIGS. 7A and 7B, the terminal 210 is performing the photographing function. More specifically, the main display portion 220 displays the external image input through a camera mounted in the terminal 210, and the user operates a button (for example, a “confirm” button) on the terminal 210 to capture an image which is currently displayed on the main display portion 220.

Referring to FIG. 7A, the display button 240 allows the user to set a photograph mode, the display button 232 allows the user to set the resolution, the display button 234 allows the user to set a photometry method, and the display button 238 allows the user to put a sepia effect on a captured image, which makes the image look old and faded. Also, the display button 240 allows the user to hide icons from the main display portion 220, the display button 242 allows the user to apply a frame image to a photographed image, the display button 246 allows the user to turn on a flash, and the display button 248 allows the user to set a self-timer.

In FIG. 7A, the display buttons 230, 232, 234, 238, 240, 242, 246, and 248 display images which include one of predetermined pop-up images. Here, the pop-up images indicate images which match a specific function (for example, a function to set a shoot mode) of the terminal 210 from among the images that each display button 230 through 252 can display. In this case, it is preferable that the images matching the specific function, that is, the pop-up images, are more than one. In FIGS. 7A and 7B, the predetermined pop-up images are “normal mode”, “burst mode”, “multi-shot mode”, and “moving picture mode.” The normal mode is a default shooting mode, the burst mode is for shooting the same subject continuously at certain times, the multi-shot mode is for shooting different subjects at certain times, and the moving picture mode is for photographing moving pictures instead of still images.

Referring to FIG. 7A, when the user operates the display button 230 to select a pop-up image, some display buttons, for example, 230, 232, 238, and 246 display the predetermined pop-up images as shown in FIG. 7B. In this case, referring to FIG. 7B, the display buttons 234, 240, 242, and 248, which do not display the pop-up images, may lower, by a certain degree, the brightness of the images, which has been displayed thereon as shown in FIG. 7A. That is, referring to FIG. 7B, once the user operates one of the display buttons 230, 232, 238, and 246, the terminal 210 is set to the shoot mode corresponding to the operated display button, and thus the user can operate the terminal 210 to set the shoot mode with minimum operation.

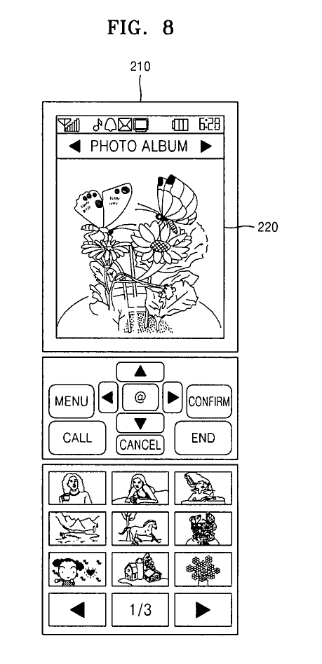

Referring to FIG. 8, the terminal 210 is performing an image viewing function. The terminal 210 is storing a number of pictures, which is more than the number of the display buttons 230 through 252, and the user operates the display buttons 236 and 252 to scroll through the pictures. When the display buttons 236 and 252 are operated, the images displayed on the display buttons 230, 232, 238, 240, 242, 246, 248, and 250 are updated so that the terminal 210 scrolls through the pictures. The images displayed on the display buttons 236 and 252, through which the terminal is allowed to scroll, will be referred to as scroll images hereinafter.

In FIG. 8, the display button 244 displays the number of pages that include images which are displayed and updated on the display buttons 230, 232, 234, 238, 240, 242, 246, 248, and 250 when the scroll images are selected.

Specifically, referring to FIG. 8, the number of photos saved in the terminal is 27, and the images displayed on the display buttons 230, 232, 234, 238, 240, 242, 246, 248, and 250 are changed each time the user operates the display buttons 236 and 252. Also, each time the user operates the display buttons 236 and 252, the number of pages displayed on the display button 244 is changed in the order of ‘⅓’, ‘⅔’, ‘ 3/3’, ‘⅓, ‘⅔’, and so on.

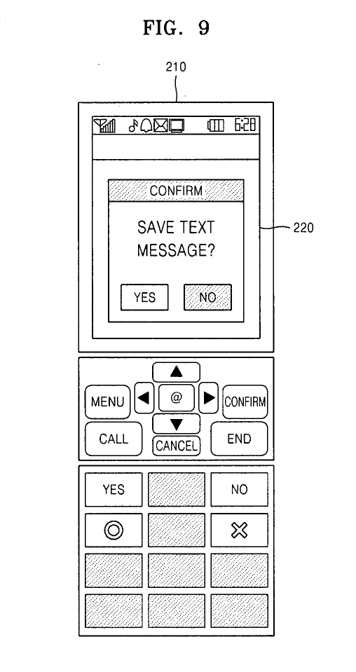

Referring to FIG. 9, the user is about to save a received text message in the terminal 210. The main display portion 220 displays an image to confirm the intention of the user, and the display buttons 230, 232, 246, and 248 displays images that show “YES”, “NO”, “⊚”, and “X” thereon as shown in FIG. 9. The images (“YES”, “NO”, “⊚”, and “X”) for selection displayed on the display buttons 230, 232, 246, and 248 are larger than images for selection displayed on the main display portion 220. The result of operating the display button 230 is the same as the result of operating the display button 232, and the result of operating the display button 246 is the same as the result of operating the display button 248.

As shown in FIG. 9, since images that show operations (for example, deletion or storing of the text message) that the user may possibly choose are displayed automatically on the display buttons 230, 232, 246, and 248 when the image that is asking to save the text message and is showing that a negative answer (“NO”) is activated is displayed on the main display portion 220, the user who wants to save the text message can simply save the text message by operating either the display buttons 230 or 232 which displays “YES” or “⊚” for the operation of storing the text message without viewing the main display portion 220, the display buttons 230 through 252 and other non-display buttons and without performing additional operations, for example, pressing a [symbol] button and a confirm button so as to activate a “YES” button.

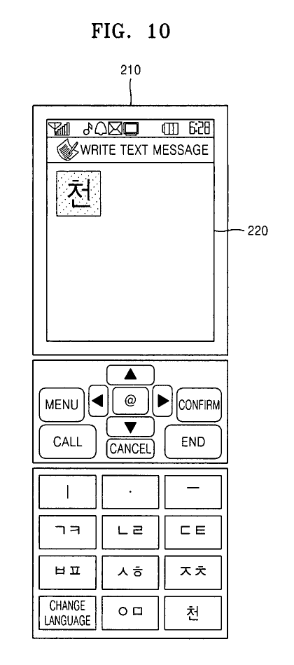

Referring to FIG. 10, the user is writing a text message using the terminal 210. The display buttons 230, 232, 234, 238, 240, 244, 246, 248, and 250 display images of Hangul as shown in FIG. 10. When the user operates the display button 236, the display buttons 230, 232, 234, 238, 240, 244, 246, 248, and 250 change images to input an alphabet.

As shown in FIG. 10, the result of operating the display buttons 230, 232, 234, 238, 240, 244, 246, 248, and 250 may be shown in the display button 252 as well as the main display portion 220. Accordingly, the user can check which letters he or she put by viewing the display button while pressing the display buttons 230, 232, 234, 238, 240, 244, 246, 248, and 250 without viewing the main display portion 220, and thus the operational convenience for the user can be achieved by minimizing the distance of eye movement required to operate the buttons 230, 232, 234, 238, 240, 244, 246, 248, and 250.

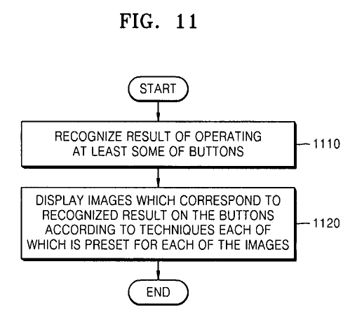

FIG. 11 is a flowchart of a display method according to an embodiment of the present invention. The display method may include operations that maximize the operational convenience for a user who operates buttons on a compact terminal with various applicable functions to perform a certain function. The display method will be described in conjunction with FIG. 1.

The control unit 120 recognizes the result of operating at least some of the plurality of buttons 110 (operation 1110).

Each of the buttons 110 displays individual images which correspond to the recognized result obtained in operation 1110 according to techniques preset for each of the images (operation 1120).

The display method of the present invention can be written as computer programs and can be implemented in general-use digital computers that execute the programs using a computer readable recording medium. Examples of the computer readable recording medium include magnetic storage media (e.g., ROM, floppy disks, hard disks, etc.), and optical recording media (e.g., CD-ROMs, or DVDs).

As described above, a terminal and a display method of the terminal according to the present invention recognize the result of operating at least some of a plurality of buttons, and display a plurality of images corresponding to the recognized result on the buttons according to techniques which are preset for each of the images. Thus, operational convenience can be maximized for a user who operates the buttons on the terminal, which is compact and has various applicable functions, in order to indicate a certain function.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A terminal comprising:
a plurality of buttons which display a plurality of images in response to a control signal; and
a control unit which generates the control signal corresponding to a result of operating at least some of the plurality of buttons, the control signal directing the buttons to display the images according to techniques, each of the techniques is preset for each of the images.

2. The terminal of claim 1, wherein each of the buttons displays each of the images with a color predetermined for each image.

3. The terminal of claim 2, wherein the color for each image is decided according to a function of the terminal denoted by each image.

4. The terminal of claim 2, wherein the color for each image is decided according to how many times the each image is selected at a predetermined period of time.

5. The terminal of claim 2, wherein the color for each image is decided according to a value denoted by each image.

6. The terminal of claim 1, wherein the images that identify buttons which are operated are displayed on the buttons.

7. The terminal of claim 6, wherein images that are displayed on the operated buttons blink several times on the operated buttons.

8. The terminal of claim 1, wherein when one of a plurality of predetermined pop-up images is selected, images displayed on at least some of the buttons are updated to the pop-up images.

9. The terminal of claim 8, wherein images that was not updated to pop-up images are displayed on the buttons with less brightness.

10. The terminal of claim 1, wherein the images include at least one of scroll image through which the terminal can scroll and a page image that shows the number of pages, each of the pages includes the images which are displayed on the buttons and updated when the scroll image is selected.

11. The terminal of claim 1, wherein the images include a plurality of images, each of the plurality of images leads the terminal to the same operating result when each of the plurality of the images is selected.

12. The terminal of claim 1, wherein at least some of the buttons display the operating result.

13. A display method which is performed in a terminal having a plurality of buttons, the display method comprising:
recognizing a result of operating at least some of the buttons; and
displaying a plurality of images corresponding to the recognized result on the buttons according to techniques, each of the techniques is preset for each of the images.

14. The display method of claim 13, wherein in the display of the plurality of images, each of the buttons displays each of the images with a color predetermined for each image.

15. The display method of claim 14, wherein the color for each image is decided according to a function of the terminal denoted by each image.

16. The display method of claim 14, wherein the color for each image is decided according to how many times the each image is selected at a predetermined period of time.

17. The display method of claim 14, wherein the color for each image is decided according to a value denoted by each image.

18. The display method of claim 13, wherein in the display of the plurality of images, the images that identify buttons which are operated are displayed on the buttons.

19. The display method of claim 18, wherein in the display of the plurality of images, images that are displayed on the operated buttons blink several times on the operated buttons.

20. The display method of claim 13, wherein when one of a plurality of predetermined pop-up images is selected, images displayed on at least some of the buttons are updated to the pop-up images.

21. The display method of claim 20, wherein images that was not updated to pop-up images are displayed on the buttons with less brightness.

22. The display method of claim 13, wherein the images include at least one of scroll image through which the terminal can scroll and a page image that shows the number of pages, each of the pages includes the images which are displayed on the buttons and updated when the scroll image is selected.

23. The display method of claim 13, wherein the images include a plurality of images, each of the plurality of images leads the terminal to the same operating result when each of the plurality of the images is selected.

24. The display method of claim 13, wherein in the display of the plurality of images, at least some of the buttons display the operating result.

25. A computer readable recording medium having embodied thereon a computer program for executing the method as claimed in any one of claims 13 to 24.
